(19) United States
(12) Patent Application Publication
(10) Pub. No.: US 2004/0150943 A1
(43) Pub. Date: Aug. 5, 2004

(54) Decorative frame assembly and kit for use in combination with a computer monitor

(76) Inventor: Susan A. Rock, Winthrop Harbor, IL (US)

Correspondence Address: MERONI + MERONI, P.O. BOX 309, BARRINGTON, IL, 60011, US

(21) Appl. No.: 10/357,141

(22) Filed: Feb. 3, 2003

(51) Int. Cl. G06F 1/16

(52) U.S. Cl. 361/681

(57) ABSTRACT

The present invention provides a computer monitor ornamentation system, which essentially comprises in combination a computer monitor, a conjugate frame member, and a plurality of decorative articles. The computer monitor comprises a view screen and a view screen peripheral border. The conjugate frame member comprises a peripheral border attachment surface and a decorative article attachment surface and functions to interface the decorative articles with the view screen peripheral border. Border-frame fasteners function to removably attach the conjugate frame member to the view screen peripheral border and frame-article fasteners function to removably receive the decorative articles in user-selected arrangements. Each decorative article essentially comprises a decorative surface, a frame-engaging surface and a button fixedly attached to the frame-engaging surface. The system thus enables a user to continuously enhance the user's field of monitor view by removably attaching the decorative articles to the conjugate frame member in user-selected arrangements.

### BACKGROUND OF THE INVENTION

1. Field of the Invention

The present invention generally relates to a means for decorating or outfitting a display screen. More particularly, the present invention relates to a decorative frame assembly and kit for outfitting the perimeter of a typical computer monitor display screen, television viewing screen and the like. Specifically, the present invention relates to a uniquely configured frame assembly, the parts of which can be readily interchanged and/or rearranged to provide a continuously alterable decorative frame for use in combination with a view screen to enhance the user's field of view.

2. Description of the Prior Art

It is noted that with the introduction of personal computers in the late 1970's, and the continued acceptance and popularity of personal computers through to the present day, the computer industry has grown considerably. In the wake of this growth are numerous entrepreneurs finding niche markets for computer hardware, computer software, and computer hardware accessories. Among the various kinds of computer hardware accessories are protective accessories, ergonomic accessories, and decorative accessories to list just a few. Decorative computer accessories, in particular, have begun to be developed as an offshoot of the broader based computer industry and markets continue to evolve in response to this development.

Typically, users of computers are enabled to receive or perceive computer generated information via various output devices. One of the most common devices for enabling users to perceive computer generated information is through the use of visual output devices such as a view screen or computer monitor display screen. Viewing screens or computer monitor display screens typically comprise a substantially vertical display screen and a view screen peripheral border, both of which are typically rectangular in shape. The view screen peripheral border essentially frames the display screen and may comprise interactive components such as a power button, viewing adjustment means and the like. Means for decorating the typical computer monitor are now known and in this regard, the prior art teaches a variety of decorative computer monitor accessories, some of which are described hereinafter.

For example, U.S. Pat. No. 5,072,998 ('998 patent), which issued to Oh, discloses Stuffed Anatomical Members. The '998 patent teaches plush stuffed anatomical members for mounting on a computer monitor or a like object to make the object less intimidating to children and therefore encourage its use by children. The stuffed anatomical members may include a head member, two arm members, and two feet members. Each member is detachably secured to the object using hook and loop type or VELCRO-type fastenings.

It will be seen from a review of the '998 patent, however, that the disclosed Stuffed Anatomical Members do not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '998 patent does not teach a decorative frame assembly usable in combination with a computer monitor or view screen, which assembly firstly comprises a conjugate frame member sized and shaped to overlay the computer monitor or view screen peripheral border, and secondly comprises a plurality of decorative articles removably attachable to the conjugate frame member in user-selected arrangements, thus enabling a user to continuously enhance the user's field of monitor view. Further, the '998 patent does not teach a conjugate frame member comprising flexible, fibrous, felt-like material having outwardly extending loop-like fibers, which fibers functionally serve as loop fastening means matable with hook fastening means. The '998 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 5,464,214 ('214 patent), which issued to Griffin, discloses a Device for Enhancing the Appeal of a Video Terminal. The '214 patent teaches a three-dimensional amusement device for transforming the outer appearance of a video terminal thus enhancing its appeal and improving the state of the mind of the person requiring its use, particularly when that person is a child. The device of the '214 patent essentially comprises a stretchable skirt structure mountable to the video display screen and a three dimensional object supported by the stretchable skirt structure.

It will be seen from a review of the '214 patent, however, that the disclosed Device for Enhancing the Appeal of a Video Terminal does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '214 patent does not teach a decorative frame assembly usable in combination with a computer monitor or view screen, which assembly firstly comprises a conjugate frame member sized and shaped to overlay the computer monitor or view screen peripheral border, and secondly comprises a plurality of decorative articles removably attachable to the conjugate frame member in user-selected arrangements, thus enabling a user to continuously enhance the user's field of monitor view. Further, the '214 patent does not teach a conjugate frame member comprising flexible, fibrous, felt-like material having outwardly extending loop-like fibers, which fibers functionally serve as loop fastening means matable with hook fastening means. The '214 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 5,564,209 ('209 patent), which issued to Zagnoli, discloses an Apparatus for Positioning Around the Screen of a Cathode Ray Tube. The '209 patent teaches an apparatus for positioning around the screen of a cathode ray tube, which apparatus comprises a strap of a flexible material with a circumference that allows it to be positioned around the upper surface, lower surface and side surfaces of a cathode ray tube. The strap is adjacent the screen end of the cathode ray tube. The strap assumes a generally rectangular configuration when placed around the screen. The strap, when positioned around the cathode ray tube, forms two vertical side extents, a horizontal upper extent, and a lower horizontal extent. A pile type fastening is secured to a central region of the upper extent of the strap. An adjustable structure is in the lower extent of the strap diametrically opposed from the strap. A replaceable decorative attachment is attached and supported by the strap and pile-type fastening.

It will be seen from a review of the '209 patent, however, that the disclosed Apparatus for Positioning around the Screen of a Cathode Ray Tube does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '209 patent does not teach a decorative frame assembly usable in combination with a computer monitor or view screen, which assembly firstly comprises a conjugate frame member sized and shaped to overlay the computer monitor or view screen peripheral border, and secondly comprises a plurality of decorative articles removably attachable to the conjugate frame member in user-selected arrangements, thus enabling a user to continuously enhance the user's field of monitor view. Further, the '209 patent does not teach a conjugate frame member comprising flexible, fibrous, felt-like material having outwardly extending loop-like fibers, which fibers functionally serve as loop fastening means matable with hook fastening means. The '209 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 5,638,096 ('096 patent), which issued to Schwartz, discloses a Computer Screen Frame. The '096 patent teaches a framing device that enhances a computer user's visual environment by providing a useful and/or aesthetically pleasing frame for the computer display screen. The framing device is removably attached to a computer monitor peripheral border in a manner that permits substantially the entire display screen to be viewed through an opening in the screen frame.

It will be seen from a review of the '096 patent, however, that the disclosed Computer Screen Frame does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '096 patent does not teach a decorative frame assembly usable in combination with a computer monitor or view screen, which assembly comprises in combination a conjugate frame member sized and shaped to overlay the computer monitor or view screen peripheral border, and a plurality of decorative articles removably attachable to the conjugate frame member in user-selected arrangements, thus enabling a user to continuously enhance the user's field of monitor view. Further, the '096 patent does not teach a conjugate frame member comprising flexible, fibrous, felt-like material having outwardly extending loop-like fibers, which fibers functionally serve as loop fastening means matable with hook fastening means. The '096 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 5,759,644 ('644 patent), which issued to Stanley, discloses a Decorative Computer Monitor Cover. The '644 patent teaches a decorative cover for computer monitors having a covering material assembly made of a flexible covering material configured to conform to the general size and shape of the forward portion of a computer monitor. The cover has an opening through which the computer monitor screen may be directly viewed while the cover is in place on the monitor. The cover opening is maintained by a preformed support member made of a semi-rigid material, which is attached to the covering material. The cover is held in place on the monitor by securing means comprises of elastic banding and/or hook and loop (VELCRO) fastening strips.

It will be seen from a review of the '644 patent, however, that the disclosed Decorative Computer Monitor Cover does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '644 patent does not teach a decorative frame assembly usable in combination with a computer monitor or view screen, which assembly comprises in combination a conjugate frame member sized and shaped to overlay the computer monitor or view screen peripheral border, and a plurality of decorative articles removably attachable to the conjugate frame member in user-selected arrangements, thus enabling a user to continuously enhance the user's field of monitor view. Further, the '644 patent does not teach a conjugate frame member comprising flexible, fibrous, felt-like material having outwardly extending loop-like fibers, which fibers functionally serve as loop fastening means matable with hook fastening means. The '644 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 5,894,878 ('878 patent), which issued to Morgan et al., discloses a Protective and Decorative Computer Cover. The '878 patent teaches a covered casing assembly, which assembly includes a fabric member made of an elastic material, such as a Spandex containing material. The material is stretched over a casing and has at least one opening surrounding an accessible feature of the casing. The fabric member may be in the form of a tube having two openings, one at each end of the openings at each end of the tube. An aperture adjustment feature is provided for sizing and shaping an aperture in the fabric member. Such a feature may be tabs formed by slits extending into the fabric member from around the periphery of the opening and the tabs are bent under the fabric member between the fabric member and the casing. Another more particular embodiment of the invention includes symbols or a design printed on an outside of the tube.

It will be seen from a review of the '878 patent, however, that the disclosed Protective and Decorative Computer Cover does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '878 patent does not teach a decorative frame assembly usable in combination with a computer monitor or view screen, which assembly firstly comprises a conjugate frame member sized and shaped to overlay the computer monitor or view screen peripheral border, and secondly comprises a plurality of decorative articles removably attachable to the conjugate frame member in user-selected arrangements, thus enabling a user to continuously enhance the user's field of monitor view. Further, the '878 patent does not teach a conjugate frame member comprising flexible, fibrous, felt-like material having outwardly extending loop-like fibers, which fibers functionally serve as loop fastening means matable with hook fastening means. The '878 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 6,209,973 ('973 patent), which issued to Steinberg, discloses a Computer Monitor Cover. The '973 patent teaches a cover for a computer monitor housing having a visual display screen. The cover comprises a containment member having a top panel and a pair of side panels attached thereto. The containment member is substantially constructed of fabric material and is adapted to receive at least a portion of the computer monitor housing. Coupled to the top panel and the side panels of the containment member is a front panel adapted to overlay the screen of the computer monitor housing. Further, a plurality of appendages may be attached to the containment member.

It will be seen from a review of the '973 patent, however, that the disclosed Computer Monitor Cover does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '973 patent does not teach a decorative frame assembly usable in combination with a computer monitor or view screen, which assembly firstly comprises a conjugate frame member sized and shaped to overlay the computer monitor or view screen peripheral border, and secondly comprises a plurality of decorative articles removably attachable to the conjugate frame member in user-selected arrangements, thus enabling a user to continuously enhance the user's field of monitor view. Further, the '973 patent does not teach a conjugate frame member comprising flexible, fibrous, felt-like material having outwardly extending loop-like fibers, which fibers functionally serve as loop fastening means matable with hook fastening means.

The '973 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

U.S. Pat. No. 6,402,269 ('269 patent), which issued to Roth, discloses a Decorative Computer Monitor Cover. The '269 patent teaches a decorative cover for a computer monitor constructed from pliable material that enables it to be placed over a computer monitor to protect it from hazardous elements. The decorative cover is also in the form of an animal that will enhance the appeal of the computer to a given group of computer users. There is also a conductive material disposed inside of the decorative cover that helps discharge electrostatic charges from the computer monitor when the cover is placed over the monitor and in contact with the ground.

It will be seen from a review of the '269 patent, however, that the disclosed Decorative Computer Monitor Cover does not teach a computer monitor or view screen ornamentation system for enabling a user to continuously enhance the user's field of monitor or screen view, which ornamentation system comprises readily interchangeable and/or rearrangeable decorative articles to provide a continuously alterable decorative frame removably mountable to the anterior periphery of a computer monitor or view screen. It will be further seen that the '269 patent does not teach a decorative frame assembly usable in combination with a computer monitor or view screen, which assembly firstly comprises a conjugate frame member sized and shaped to overlay the computer monitor or view screen peripheral border, and secondly comprises a plurality of decorative articles removably attachable to the conjugate frame member in user-selected arrangements, thus enabling a user to continuously enhance the user's field of monitor view. Further, the '269 patent does not teach a conjugate frame member comprising flexible, fibrous, felt-like material having outwardly extending loop-like fibers, which fibers functionally serve as loop fastening means matable with hook fastening means. The '269 patent further does not teach decorative articles comprising hook fastening means matable with the described fibrous conjugate frame member such that the decorative articles may be removably attached to the conjugate frame member in user-selected arrangements, thus enabling a user to continuously and quickly enhance the user's field of monitor view according to the user's whim and fancy.

Of the several computer monitor or view screen decorative devices that have been developed, some provide field of view enhancement means for increasing the visual attractiveness of a computer monitor screen or other similar view screen. In this regard, it has been shown that computer monitor or view screen decorative devices of various types are known in the prior art. However, in addition to often being exorbitantly priced, the computer monitor or view screen decorative devices that have been developed are often cumbersome to practice, requiring the user to outfit the view screen or monitor with heavy and/or bulky adornments. In the workplace, for example, bulky monitor adornments are often frowned upon insofar as the adornments may be distracting to others or foster an air of unprofessionalism. In this regard, it is noted that the prior art computer monitor or view screen decorative devices do not allow the user to readily adorn the anterior periphery of a monitor or view screen such that the user may more easily maintain a subtle or non-distracting monitor or view screen enhancement system. In other words, the prior art computer monitor or view screen decorative devices do not enable users to readily manipulate user-viewable ornamental pieces located on the anterior periphery of a monitor view screen.

Further the prior art computer monitor or view screen decorative devices that have been developed do not allow the user to readily interchange and/or rearrange the decorative adornments such that the anterior periphery of a monitor or view screen may be dynamically enhanced. Further, the prior art computer monitor or view screen decorative devices that have been developed do not allow the user to readily interchange and/or rearrange thematic adornments such that the anterior periphery of a monitor or view screen may be dynamically enhanced in an inconspicuous manner. For example, while the '998 patent teaches the use of dinosaur-themed Stuffed Animal Members removably attached to the outer monitor housing, the disclosure is limited to anatomically shaped members, arrangeable in anatomical configurations which extend from the outer monitor housing so as to be conspicuous. As a further example, while the '214 patent teaches the use of a Santa-themed Device for Enhancing the Appeal of a Video Terminal, the '214 patent disclosure does not teach readily interchangeable and/or rearrangeable Christmas-themed adornments such that the anterior periphery of a monitor or view screen may be dynamically enhanced according to inconspicuously maintanined Christmas themes.

Further the prior art computer monitor or view screen decorative devices that have been developed do not teach the use of decorative fastening means usable to attach decorative articles to a given computer monitor or view screen. Often, the fastening means comprise distracting attachment structures which tend to decrease the visual appeal as well as the value of a computer monitor. For this and other reasons, fastening means are, at one extreme, often discouraged from being affixed or attached to computer monitor housings, and at another extreme, banned from computer monitor housings altogether. The prior art does not teach fastening means, which are highly decorative or visually appealing.

The prior art thus perceives a need for computer monitor or view screen ornamentation or enhancement system that is low is cost and less cumbersome to practice. In this last regard, it is contemplated that the prior art perceives a need for computer monitor or view screen ornamentation system that enables the user to outfit the view screen or monitor with lightweight, subtle or inconspicuous, user-viewable adornments. The prior art perceives a need for a computer monitor or view screen ornamentation system that is less distracting to others and fosters a greater degree of professionalism in the workplace. In this regard, the prior art perceives a need for a computer monitor or view screen ornamentation system that enables the user to readily adorn the anterior periphery of a monitor or view screen such that the user may more easily maintain a subtle or non-distracting monitor or view screen enhancement system. In other words, the prior art perceives a need for a computer monitor or view screen decorative device that enables users to readily manipulate user-viewable ornamental pieces located on the anterior periphery of a monitor view screen.

Further the prior art perceives a need for computer monitor or view screen decorative assemblage that enables the user to readily interchange and/or rearrange decorative adornments such that the anterior periphery of a monitor or view screen may be dynamically or continuously enhanced according to the user's whim and fancy. Further, the prior art perceives a need for computer monitor or view screen decorative assemblage that enables the user to readily interchange and/or rearrange thematic adornments such that the anterior periphery of a monitor or view screen may be dynamically enhanced according to themes in an inconspicuous manner. In this regard, the prior art perceives a need for a computer monitor or view screen decorative assemblage that, for example, teaches the use of dinosaur-themed decorative articles removably attachable to the anterior periphery of a computer monitor housing, thus enabling the user to continuously or dynamically interchange and/or rearrange the decorative articles to enhance the anterior periphery in an inconspicuous manner. As a further example, the prior art perceives a need for a computer monitor or view screen decorative assemblage that teaches the use of Christmas-themed decorative articles removably attachable to the anterior periphery of a computer monitor housing, thus enabling the user to continuously or dynamically interchange and/or rearrange the decorative articles to enhance the anterior periphery in an inconspicuous manner.

Further, the prior art perceives a need for a computer monitor or view screen decorative assemblage that provides decorative fastening means usable to attach decorative articles to a given computer monitor or view screen. As earlier stated, the prior art fastening means often comprise distracting attachment structures which tend to decrease the visual appeal as well as the value of a computer monitor. The prior art thus perceives a need for fastening means, which are highly decorative or visually appealing.

### SUMMARY OF THE INVENTION

Accordingly, it is an object of the present invention to provide a visual enhancement system for use in combination with a computer monitor or other similar type view screen. In this regard, it is a further object of the present invention to provide a computer monitor or view screen ornamentation system that is low is cost and less cumbersome to practice. It is a further object of the present invention to provide a computer monitor or view screen ornamentation system that enables the user to outfit the view screen or monitor with lightweight, subtle or inconspicuous, user-viewable adornments. It is a further object of the present invention to provide a computer monitor or view screen ornamentation system that is less distracting to others or enables workplace users to foster a higher standard of professionalism. Further, it is an object of the present invention to provide a computer monitor or view screen ornamentation system that enables the user to readily adorn the anterior periphery of a monitor or view screen such that the user may more easily maintain a subtle or non-distracting monitor or view screen enhancement system. In other words, it is an object of the present invention to provide a computer monitor or view screen decorative device that enables users to readily manipulate user-viewable ornamental pieces located on the anterior periphery of a monitor view screen.

Further, it is an object of the present invention to provide a computer monitor or view screen decorative assemblage that enables the user to readily interchange and/or rearrange decorative adornments such that the anterior periphery of a monitor or view screen may be dynamically or continuously enhanced according to the user's whim and fancy. Further, it is an object of the present invention to provide a computer monitor or view screen decorative assemblage that enables the user to readily interchange and/or rearrange thematic adornments such that the anterior periphery of a monitor or view screen may be dynamically enhanced according to themes, which decorative monitor themes may be practiced in a relatively inconspicuous fashion. In this regard, it is an object of the present invention to provide a computer monitor or view screen decorative assemblage that, for example, teaches the use of dinosaur-themed decorative articles removably attachable to the anterior periphery of a computer monitor housing, thus enabling the user to continuously or dynamically interchange and/or rearrange the dinosaur-themed decorative articles to enhance the anterior periphery in a relatively inconspicuous manner. As a further example, an object of the present invention is to provide a computer monitor or view screen decorative assemblage that teaches the use of Christmas-themed decorative articles removably attachable to the anterior periphery of a computer monitor housing, thus enabling the user to continuously or dynamically interchange and/or rearrange the Christmas-themed decorative articles to enhance the anterior periphery in a relatively inconspicuous manner.

It is a further object of the present invention to provide a computer monitor or view screen decorative assemblage that provides decorative fastening means usable to attach decorative articles to a given computer monitor or view screen. As stated, the prior art fastening means often comprise distracting attachment structures which tend to decrease the visual appeal as well as the value of a computer monitor. It is thus a further object of the present invention to provide fastening means, which are highly decorative or visually appealing.

To achieve these and other readily apparent objectives, the present invention provides a computer monitor or view screen ornamentation system for enabling a user to continuously enhance the user's field of monitor view. The computer monitor ornamentation system essentially comprises in combination a computer monitor, a conjugate frame member, and a plurality of decorative articles. The computer monitor comprises a substantially vertical view screen, which view screen in turn comprises a substantially rectangular view screen peripheral border. The conjugate frame member, in likewise construction, is also of a substantially rectangular configuration and further comprises a peripheral border attachment surface and a decorative article attachment surface. Border-frame fastening means are fixedly attached to the peripheral border surface, which function to removably attach the conjugate frame member to the view screen peripheral border. Frame-article fastening means are fixedly attached to the decorative article attachment surface, which function to removably receive the decorative articles in user-selected arrangements. Each decorative article essentially comprises a decorative surface, a frame-engaging surface, a button fixedly attached to the frame-engaging surface, and article fastening means fixedly attached to the button. The article fastening means function to removably attach each of the decorative articles to the frame-article fastening means in user-selected arrangements as indicated above. The summarized system thus enables a user to continuously enhance the user's field of monitor view by removably attaching the decorative articles to the conjugate frame member in user-selected arrangements.

The border-frame fastening means may be further summarized by comprising matable border loop fastening means or fastening means comprising loop type fastening structure fixedly attached to the view screen peripheral border and matable border hook fastening mean or fastening means comprising hook type fastening structure fixedly attached to the peripheral attachment surface. The border loop fastening means and the border hook fastening means are thus matable and function to position the conjugate frame member in anterior adjacency to the view screen peripheral border. The conjugate frame member is sized and shaped to overlay the view screen peripheral border so as to allow the user to readily view the entire view screen of the computer monitor or other similar display unit.

The frame-article fastening means may be further summarized by comprising matable frame loop fastening means and the article fastening means may be further summarized by comprising matable article hook fastening means. The frame loop fastening means and the article hook fastening means are thus matable and function to position each decorative article in anterior adjacency to the conjugate frame member. Each decorative article is typically sized and shaped to overlay the conjugate frame member so as to allow the user to readily view the view screen of the computer monitor or other similar display unit.

Each button, article hook fastening means, and frame loop fastening means may be further summarized by comprising substantially circular configurations. In this regard, it is contemplated that the frame loop fastening means of a substantially circular configuration are more visually appealing and thus more decorative in nature. As summarized, it may be seen that the frame loop fastening means are readily viewable when corresponding decorative articles are removed from the conjugate frame member. It is thus contemplated that the present invention provides a decorative frame loop fastening means for removably receiving the decorative articles.

It is further contemplated that an alternative conjugate frame member may be summarized by comprising a flexible, fibrous felt-like fabric material. The fibrous felt-like material further comprises outwardly extending loop-like fibers, which fibers may further define the frame loop fastening means in the alternative embodiment. In the noted alternative embodiment, matable border hook fastening means are fixedly attached to the view screen peripheral border for removable receiving outwardly extending loop-like fibers, which fibers are also situated on the peripheral attachment surface. The border hook fastening means and loop-like fibers on the peripheral attachment surface are thus matable and function to position the conjugate frame member in anterior adjacency to the view screen peripheral border.

Further, the decorative article attachment surface, frame loop fastening means, and each decorative surface may be further summarized by comprising decorative coloration. As summarized, it may be seen that the decorative article attachment surface and frame loop fastening means are readily viewable when corresponding decorative articles are removed from the conjugate frame member. It is thus contemplated that the present invention provides a decorative frame attachment surface as well as decorative frame loop fastening means for removably receiving the decorative articles. Furthermore, it may be seen that the decorative surfaces are readily viewable when corresponding decorative articles are removably attached to the conjugate frame member. It is thus contemplated that the present invention provides a decorative frame attachment surface as well as decorative frame loop fastening means for removably receiving the decorative articles and serving as a decorative backdrop against which decorative surfaces may be viewed.

In this last regard, it should be noted that the decorative articles may be further summarized by comprising thematic decorative articles. In other words, the decorative articles may collectively contribute to a theme which the user wishes to dynamically manipulate on or about the monitor view screen. The theme, for example, may be seasonal or regional or historical or sports-related or occupational. For example, a seasonal theme may comprise Christmas or winter themed decorative articles and a regional theme may comprise jungle or beach themed decorative articles.

Additionally, a decorative framing kit for ornamentally outfitting a computer monitor peripheral border or view screen peripheral border is provided. The decorative framing kit essentially comprises the summarized conjugate frame member. As earlier summarized, the conjugate frame member comprises a peripheral border attachment surface and a decorative article attachment surface. The conjugate frame member is formable or capable of being sized and shaped to overlay the computer monitor peripheral border or view screen peripheral border.

The decorative framing kit further comprises a plurality of decorative articles as earlier summarized. In this regard, it is contemplated that each decorative article comprises a decorative surface and a frame-engaging surface. Further, the decorative framing kit further comprises frame fastening means for removably attaching the conjugate frame member to the computer monitor peripheral border, and article fastening means for removably attaching each decorative article to the decorative article attachment surface. As earlier summarized, the decorative article attachment surface may be further defined by comprising frame loop fastening means.

Typically, users of computers are enabled to perceive computer generated information via various output devices. One of the most common devices for enabling users to perceive computer generated information is through the use of visual output device such as a view screen or computer monitor display screen. Viewing screens or computer monitor display screens typically comprise a substantially vertical display screen and a view screen peripheral border, both of which are typically rectangular in shape. The view screen peripheral border essentially frames the display screen and may comprise interactive components such as a power button, viewing adjustment means and the like. The present invention provides a view screen peripheral border ornamentation system comprising, in combination, a computer monitor, a conjugate frame member and a plurality of decorative articles as summarized above. The conjugate frame member is sized, shaped and constructed so as to interface decorative articles with the peripheral border of the anterior face of a typical computer monitor or similar other display unit. Further, the conjugate frame member may be constructed from materials having outwardly extending loop-like matable fibers, which fibers mate with hook type fastening means fixedly attached to the peripheral border and each decorative article. The decorative articles may comprise thematic decorative articles and may be readily interchanged and rearranged on the anterior periphery according to the whim and fancy of the user. The ornamentation system or decorative frame assembly of the present invention thus functions to enable display screen users to dynamically enhance the visual experience of display screen use in an inconspicuous manner.

Other objects of the present invention, as well as particular features, elements, and advantages thereof, will be elucidated in, or apparent from, the following description and the accompanying drawing figures.

### BRIEF DESCRIPTION OF THE DRAWINGS

Other features of my invention will become more evident from a consideration of the following brief description of my patent drawings, as follows:

FIG. 1 is a perspective view of the preferred embodiment of the decorative frame assembly for use in combination with a view screen showing the conjugate frame member in juxtaposed anterior relation to a view screen peripheral border.

FIG. 2 is a posterior view of the conjugate frame member showing a peripheral attachment surface and border-frame fastening means.

FIG. 3 is a left lateral view of the conjugate frame member of FIG. 2 showing border-frame fastening means and frame-article fastening means.

FIG. 4 is an anterior view of the preferred embodiment of the conjugate frame member with a first set of thematic decorative articles attached to the decorative article attachment surface of the conjugate frame member in an exemplary arrangement.

FIG. 5 is an anterior view of an alternative embodiment of the conjugate frame member with a second set of thematic decorative articles attached to the decorative article attachment surface of the conjugate frame member in an exemplary arrangement.

FIG. 6 is a top plan view of a decorative frame assembly kit showing assorted decorative articles, a rolled conjugate frame member and rolled fastening means.

FIG. 7 is a posterior perspective view of an exemplary decorative article showing the frame-engaging surface, a button fixedly attached to the frame-engaging surface, and article fastening means in juxtaposed posterior relation to the button.

### DETAILED DESCRIPTION OF THE PREFERRED EMBODIMENT

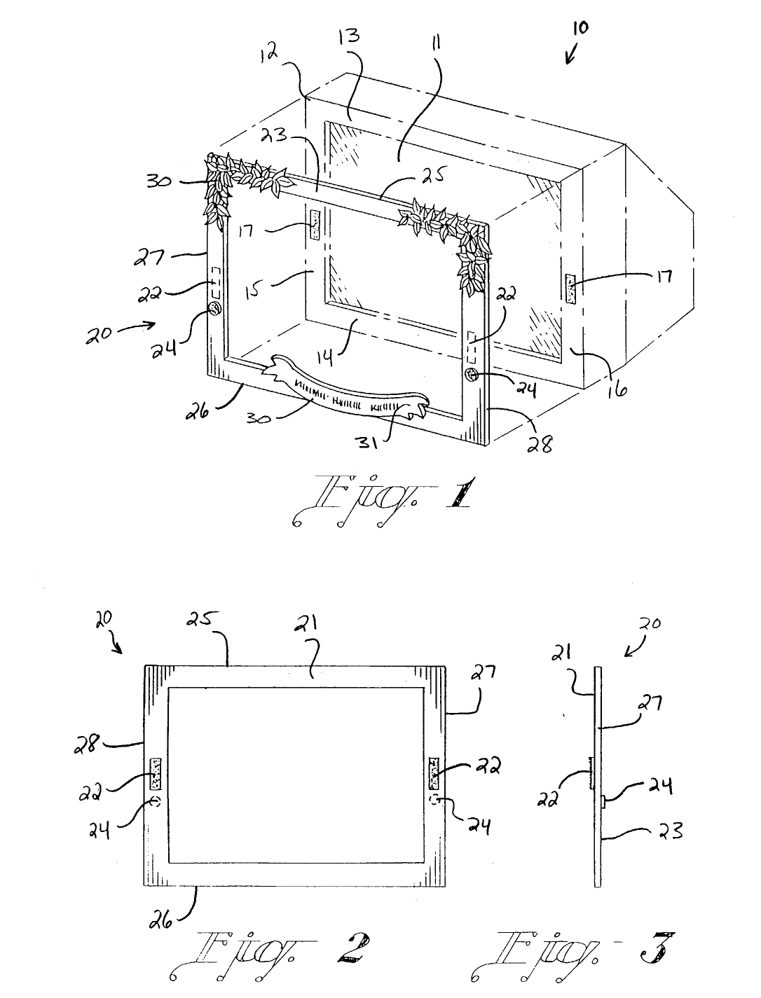

Referring now to the drawings, the preferred embodiment of the present invention concerns a computer monitor or view screen ornamentation system for enabling a user to continuously enhance the user's field of monitor view. The computer monitor ornamentation system essentially comprises in combination a computer monitor 10 as illustrated in FIG. 1; a conjugate frame member 20 as illustrated in FIG. 1-6; and a plurality of decorative articles 30 as generally illustrated in FIGS. 1, and 4-7. In this regard, it is contemplated that the present invention is usable in combination with a computer monitor 10 or similar other unit having a display screen. In other words, it is contemplated that the present invention is preferably usable in combination with computer monitor 10 or similar computer output display device or a television display screen. In this last regard, it is contemplated that the present invention is preferably usable in combination with a personal computer type monitor in that there appears to be a greater need for enhancing the field of monitor view than the field of television view. Computers are essentially machines and thus are often used to perform functions of work. Workplace scenarios often involve repetitive mundane tasks that require users to sit in front of computer monitors for a great deal of time during the typical work day. Employees often become desirous of improving the workplace surroundings in which they find themselves and the present invention attempts to address this need.

In any event, computer monitor 10 of any similarly configured output display device usable in combination with the present invention preferably comprises a substantially vertical view screen 11 and a substantially rectangular view screen peripheral border 12 as illustrated in FIG. 1. View screen peripheral border 12 preferably comprises a substantially horizontal superior base frame portion 13, a substantially horizontal inferior base frame portion 14, a substantially vertical left base frame portion 15, and a substantially vertical right base frame portion 16 all as further illustrated in FIG. 1. Further, border fastening means are preferably fixedly attached to vertical screen peripheral border 12. The border fastening means are preferably further defined by comprising border loop fastening means 17 as illustrated in FIG. 1. Border loop fastening means 17 are preferably further defined by comprising VELCRO brand loop fastening structure in contradistinction to VELCRO brand hook fastening structure. VELCRO brand loop fastening structure is the preferred matable attachment means in that air-borne fibers and other loop-like fibrous materials, which occasionally contact exposed VELCRO hook fastening structure, often become embedded in the hook type structure. Once embedded these materials and/or fibers become unsightly and are difficult to remove from the hook type structure. These embedded materials and/or fibers thus detract from the visual appearance of the fastening means when in an exposed unmated state and thus decrease the overall decorative effect of the decorate frame assembly. VELCRO brand loop fastening structure does not retain fibers or loop-like materials as does VELCRO brand hook fastening structure, and thus is the preferable fastening means. It is contemplated that users of the present invention may, for whatever reason, occasionally remove conjugate member 20 from view screen peripheral border 10 thus exposing border fastening means 17. It is with this in mind that the border fastening means preferably comprises VELCRO brand loop fastening structure so that the visual appearance of view screen peripheral border 12 may remain fiber-free as discussed above.

As illustrated in FIG. 1, border loop fastening means 17 is sized and shaped to fixedly attach to view screen peripheral border 12 such that the measured width dimension of view screen peripheral border 12 has a greater magnitude than the measured width dimension of border loop fastening means 17. While it has been shown that border loop fastening means 17 is fixedly attached to left base frame portion 15 and right base frame portion 16, border loop fastening means 17 may also be fixedly attached to superior base frame portion 13 and inferior base frame portion 14 or any combination of base frame portions. The border fastening means function to removably retain the conjugate frame member in anterior adjacency to view screen peripheral border 12. So long as the border fastening means function in this manner, the user may fixedly attach the border fastening means at user-selected regions of view screen peripheral border 12. Border loop fastening means 17 or VELCRO brand loop fastening structure are typically fixedly attached to surfaces with a strong adhesive backing and this is the preferred manner of fixed attachment for affixing border loop fastening means 17 to view screen peripheral border 12.

Further, it is contemplated that border loop fastening means 17 preferably comprises a substantially rectangular configuration as illustrated in FIG. 1. It is contemplated, however, that border loop fastening means 17 may also comprise a substantially circular configuration. In keeping with the visual appearance specifications of view screen peripheral border 12 as discussed above, the user may prefer substantially circular configured border loop fastening means 17. Circular shaped fastening means are often more attractive given the inherent symmetry of a circle and it is for this reason that the present invention may comprise substantially circular border loop fastening means.

Preferably, conjugate frame member 20 is also of a substantially rectangular configuration as generally illustrated in. FIG. 1-5, inclusive and is preferably constructed from a substantially rigid type material such as lightweight wood or lightweight durable plastic. In this regard, conjugate frame member 20 preferably comprises a substantially horizontal superior conjugate frame portion 25 as illustrated in FIGS. 1, 2, 4, and 5; a substantially horizontal inferior conjugate frame portion 26 as illustrated in FIGS. 1, 2, 4, and 5; a substantially vertical left conjugate frame portion 27 as illustrated in FIG. 1-5; and a substantially vertical right conjugate frame portion 28 as illustrated in FIGS. 1, 2, 4, and 5. Conjugate frame member 20 is thus preferably sized and shaped for removable attachment to view screen peripheral border 12 such that superior conjugate frame portion 25 overlays superior base frame portion 13; inferior conjugate frame portion 26 overlays inferior base frame portion 14; left conjugate frame portion 27 overlays left base frame portion 15; and right conjugate frame portion 28 overlays right base frame portion 16. It will thus be seen that conjugate frame member 20 is sized and shaped to overlay view screen peripheral border 12 so as to allow the user to readily view or visually perceive view screen 11 of computer monitor 10 or other similar display screen.

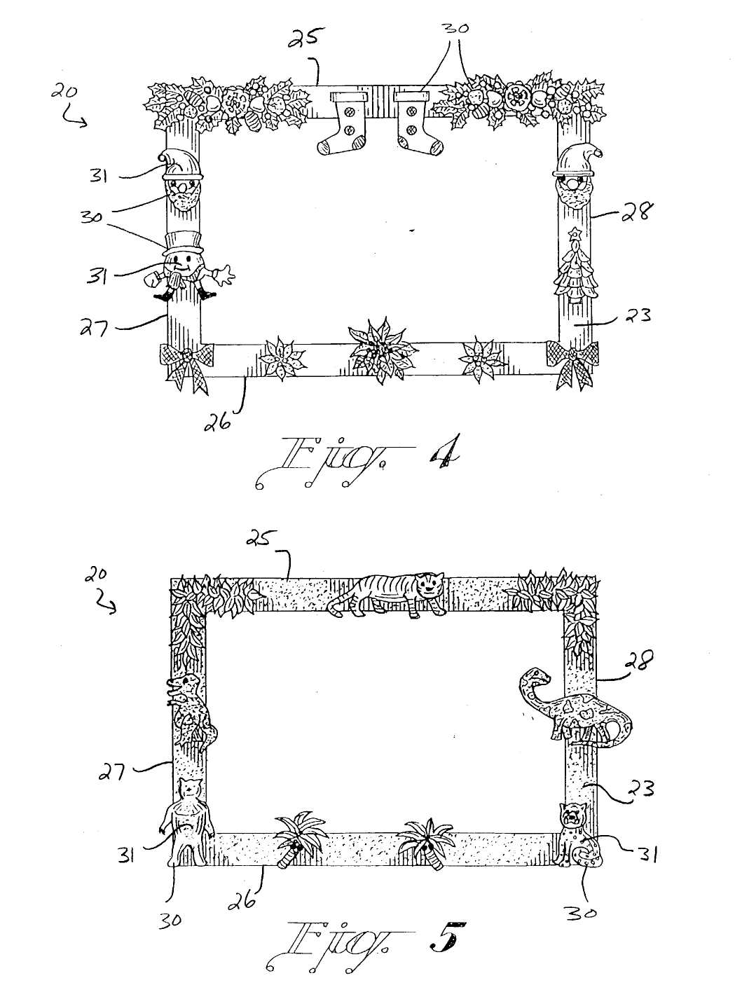

Conjugate frame member 20 preferably comprises a peripheral border attachment surface 21 as illustrated in FIGS. 2 and 3; and a decorative article attachment surface 23 as illustrated in FIGS. 1, 3-5. Border-frame or frame fastening means are fixedly attached to peripheral border surface 21, which fastening means function to removably attach conjugate frame member 20 to the border fastening means of view screen peripheral border 12. As earlier indicated, border fastening means preferably comprise VELCRO brand loop fastening structure. In this regard, the border-frame or frame fastening means preferably comprise frame hook fastening means 22 for removable mated attachment to border loop fastening means 17 as illustrated in FIG. 1-3. Notably, frame hook fastening means 22 preferably comprise or are constructed from VELCRO brand hook fastening structure. As noted above, air-borne fibers and other loop-like fibrous materials occasionally contact exposed VELCRO brand hook fastening structure and become embedded in the hook type structure. Once embedded these materials and/or fibers become unsightly and are difficult to remove from the hook type structure. These embedded materials and/or fibers thus detract from the visual appearance of the fastening means when in an exposed unmated state and thus decrease the overall decorative effect of the decorate frame assembly. However, peripheral border attachment surface 21 is typically hidden from view when in an attached state and thus the visual appearance of peripheral attachment surface 21 is not of paramount importance in contradistinction to the visual appearance of view screen peripheral border 12. Thus, while peripheral border attachment surface 21 may retain air borne fibers and the like via frame hook fastening means 22, the user or passerby of the present invention will normally be unable to visually detect the same if embedded in frame hook fastening means 22.

As illustrated in FIGS. 1 and 2, frame hook fastening means 22 are sized and shaped to fixedly attach to peripheral border attachment surface 21 such that the measured width dimension of peripheral border attachment surface 21 has a greater magnitude than the measured width dimension of frame hook fastening means 22. While it has been shown that frame hook fastening means 22 are fixedly attached to left conjugate frame portion 27 and right conjugate frame portion 28, frame hook fastening means 22 may also be fixedly attached to superior conjugate frame portion 25 and inferior conjugate frame portion 26 or any combination of conjugate frame portions. The border-frame or frame fastening means function to removably attach conjugate frame member 20 in anterior adjacency to view screen peripheral border 12. So long as border-frame or frame fastening means function in this manner, the user may fixedly attach the border-frame or frame fastening means at user-selected regions of peripheral border attachment surface 21. Frame hook fastening means 22 or VELCRO brand hook fastening structure are typically fixedly attached to surfaces with a strong adhesive backing and this is the preferred manner of fixed attachment for affixing frame hook fastening means to peripheral border attachment surface 21.

Further, it is contemplated frame hook fastening means 22 preferably comprise substantially rectangular configurations as generally illustrated in FIGS. 1 and 2. It is contemplated, however, that frame hook fastening means 22 may also comprise substantially circular configurations to match the size and shape of border loop fastening means 17. While it has been noted that circular shaped fastening means are often more attractive given the inherent symmetry of a circular configuration, it is contemplated that frame hook fastening means 22 may comprise substantially circular configurations more as a means to match the shape of border loop fastening means 17 and not necessarily for decorative purposes since peripheral border attachment surface 21 is normally hidden from view when in an attached state. As shown in FIG. 1, border loop fastening means 17 and frame hook fastening means 22 are similarly sized and shaped in the preferred substantially rectangular configurations.

Frame-article or “article to frame” fastening means are fixedly attached to decorative article attachment surface 23, which fastening means function to removably receive or removably retain decorative articles 30 in user-selected arrangements. The frame-article fastening means are preferably further defined by comprising frame loop fastening means 24 as illustrated in FIGS. 1-3, and 7. Frame loop fastening means 24 are preferably further defined by also comprising VELCRO brand loop fastening structure in contradistinction to VELCRO brand hook fastening structure. As indicated above regarding the preferred border loop fastening means 17, VELCRO brand loop fastening structure is preferable matable attachment means in that air-borne fibers and other loop-like fibrous materials occasionally contact exposed VELCRO hook fastening structure and often become embedded in the hook type structure. Once embedded these materials and/or fibers become unsightly and are difficult to remove from the hook type structure. These embedded materials and/or fibers thus detract from the visual appearance of the given fastening means when in an exposed, unmated state and thus decrease the overall decorative effect of the decorate frame assembly. VELCRO brand loop fastening structure does not retain the described fibers or loop-like materials as does VELCRO brand hook fastening structure, and thus is the preferable fastening means. It is contemplated that users of the present invention will practice the current invention and thereby dynamically enhance the user's field of monitor view by continually manipulating decorative articles in newly desired user-selected decorative article arrangements. To do so, the user must occasionally remove decorative articles 30 from decorative article attachment surface 23 of conjugate frame member 20 thus exposing frame loop fastening means 24. It is with this in mind that the frame-article fastening means preferably comprises VELCRO brand loop fastening structure so that the visual appearance of decorative article attachment surface 23 with fixedly attached frame loop fastening means 24 may also remain fiber-free as discussed above.

As illustrated in FIGS. 1 and 2, frame loop fastening means 24 are sized and shaped to fixedly attach to decorative article attachment surface 23 such that the measured width dimension of decorative article attachment surface 23 has a greater magnitude than the measured width dimension of frame loop fastening means 24. While it has been shown that frame loop fastening means 24 are fixedly attached to left conjugate frame portion 27 and right conjugate frame portion 28, frame loop fastening means 24 may also be fixedly attached to superior conjugate frame portion 25 and inferior conjugate frame portion 26 or any combination of conjugate frame portions. The frame-article fastening means function to removably retain or removably receive decorative articles 30 in anterior adjacency to conjugate frame member 20. So long as the frame-article fastening means function in this manner, the user may fixedly attach the frame-article fastening means at user-selected regions of decorative article attachment surface 23. Frame loop fastening means 24 or VELCRO brand loop fastening structure are typically fixedly attached to surfaces with a strong adhesive backing and this is the preferred manner of fixed attachment for affixing frame loop fastening means 24 to decorative article attachment surface 23.

Further, it is contemplated that frame loop fastening means 24 preferably comprise substantially circular configurations as generally illustrated in FIGS. 1, 2 and 7. In keeping with the visual appearance specifications of view screen peripheral border 12 as discussed above, substantially circular configured frame loop fastening means 24 are preferred. Circular shaped fastening means are often more attractive given the inherent symmetry of the circular configuration and it is for this reason that the present invention preferably comprises substantially circular frame loop fastening means. It is contemplated, however, that frame loop fastening means 24 may also comprise a substantially rectangular configuration.

Each decorative article 30 preferably comprises a decorative surface 31 as illustrated in FIG. 1, 4-6; a frame-engaging surface 32 as illustrated in FIG. 7; a button 33 fixedly attached to frame-engaging surface 31 as illustrated in FIG. 7; and article fastening means fixedly attached to button 33. In this regard, it is contemplated that decorative articles manufactured by CLAY CRITTERS of West Lafayette, Ind. provide excellent results when incorporated into the present invention, particularly if the user is desirous of dynamically enhancing the field of monitor or screen view with animal-themed decorative articles. CLAY CRITTERS brand decorative articles comprise a colorful decorative surface 31 and a substantially flat frame engaging surface 32 to which button 33 may easily be affixed by adhesive.

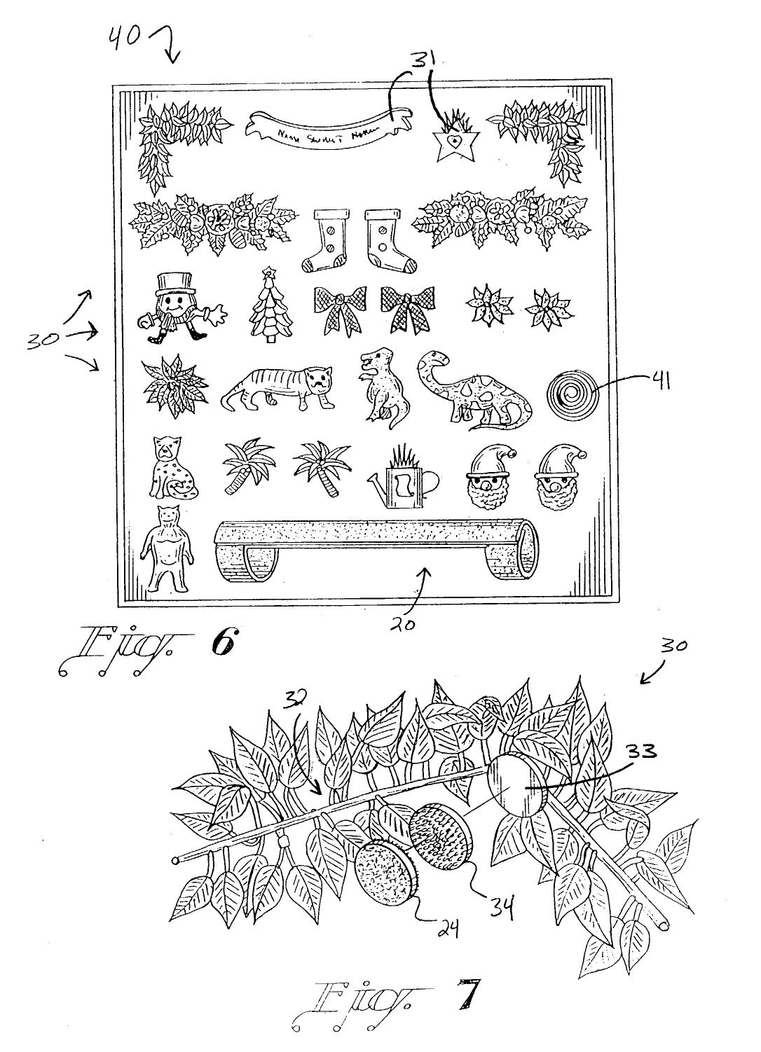

It should be noted that decorative articles 30 may preferably comprise thematic decorative articles. In other words, decorative articles 30 may collectively contribute to a theme which the user wishes to dynamically manipulate on or about the monitor view screen to continually enhance the user's field of monitor or screen view. The theme, for example, may be seasonal or regional or historical or sports-related or occupational. For example, a seasonal theme may comprise Christmas or winter themed decorative articles 30 as specifically illustrated in FIG. 4 and a regional theme may comprise jungle or beach themed decorative articles. A historical or patriotic theme may comprise a 4^{th} of July, colonial period, or “Stars and Stripes” themed decorative articles. A sports-related theme may comprise professional-level or college-level football or baseball themed decorative articles. An occupational theme may comprise medical, legal, engineering, or secretarial themed decorative articles. FIG. 5, as a further example, attempts to illustrate an animal-themed arrangement of decorative articles 30. Further, as illustrated in FIG. 6, various themed articles are available to the user; in fact, the only limitation on the number of themes readily available to the user lies in the creative impulse or whim and fancy of the user, thus further contributing to the dynamic nature of view screen enhancement capabilities inherent in the present invention.

The article fastening means function to removably attach each decorative article 30 to frame-article fastening means in user-selected arrangements as indicated above. In this regard, article fastening means preferably comprise article hook fastening means 34 as illustrated in FIG. 7, which preferably comprise or are constructed from VELCRO brand hook fastening structure. As noted above, air-borne fibers and other loop-like fibrous materials occasionally contact exposed VELCRO brand hook fastening structure and become embedded in the hook type structure. Once embedded these materials and/or fibers become unsightly and are difficult to remove from the hook type structure. These embedded materials and/or fibers thus detract from the visual appearance of the fastening means when in an exposed unmated state and thus decrease the overall decorative effect of the decorate frame assembly. However, article hook fastening means 34 are typically hidden from view when in an attached state and thus the visual appearance of article hook fastening means 34 is not of paramount importance in contradistinction to the important visual appearance of both decorative article attachment surface 23 and frame loop fastening means 24. Thus, while article hook fastening means 34 may retain air borne fibers and the like, the user or passerby of the present invention will normally be unable to visually detect the same if embedded in article hook fastening means 34.

As illustrated in FIG. 7, article hook fastening means 34 are sized and shaped to fixedly attach to button 33 such that the measured width dimension of button 33 has a magnitude substantially equal to the measured width dimension of article hook fastening means 34, which article hook fastening means has a width dimension substantially equal in magnitude to the measured width dimension of frame loop fastening means 24. Buttons 33 are incorporated into the design of each decorative article 30 for purposes of ease of attachment of the article fastening means. In this regard, article hook fastening means 34 may easily be affixed to button 33 by adhesive. Should the frame-engaging surface 32 of a given decorative article 30 not comprise a substantially flat surface to which a button 33 may easily be affixed, as is illustrated in FIG. 7, the button 33 may be secured to the frame-engaging surface 32 by means of a tie or thread-type securing structure (not illustrated). Alternatively, a combination of a tie or thread-type structure and adhesive may securely fasten the button 33 to the frame-engaging surface 32.

The article fastening means function to removably attach each decorative article 30 in anterior adjacency to decorative article attachment surface 23 of conjugate frame member 20. So long as article fastening means function in this manner, the user may removably attach decorative articles 30 in user-selected arrangements on decorative article attachment surface 23. It will be seen from a general inspection of FIGS. 1, 4 and 5 that each decorative article 30 is sized and shaped to overlay or attach to decorative article attachment surface 23 so as to allow the user to readily view or visually perceive view screen 11 of computer monitor 10 or other similar display screen.

Further, it is contemplated that article hook fastening means 34 preferably comprises substantially circular configurations to match the size and shape of frame loop fastening means 24 as illustrated in FIG. 7. It is contemplated, however, that article hook fastening means 34 may also comprise substantially rectangular configurations. While it has been noted that circular shaped fastening means are often more attractive given the inherent symmetry of a circular configuration, it is contemplated that article hook fastening means 34 may comprise substantially circular configurations more as a means to match the shape of frame loop fastening means 24 and not necessarily for decorative purposes since frame-engaging surface 32 is normally hidden from view when in an attached state. As shown in FIG. 7, article hook fastening means 34 and frame loop fastening means 24 are similarly sized and shaped in the preferred substantially circular configurations.

It is further contemplated that decorative article attachment surface 23, frame loop fastening means 24, and each decorative surface 31 preferably comprise decorative coloration for enhancing the overall decorative effect of the decorative frame assembly. In this regard, it is contemplated that decorative article attachment surface 23, being decoratively colored, provides a decorative backdrop against which to place decorative articles 30, thus enhancing the overall decorative effect of the present invention. Further, it is contemplated that decoratively colored frame loop fastening means 24 provide colorful visual effects when decorative articles 30 are in a state of removal from conjugate frame member 20, thus enhancing the overall decorative effect of the present invention. Further still, it is contemplated that decoratively colored decorative articles 30 provide the user with a final visual enhancement to the fully assembled decorative frame assembly of the present invention, wherein decorative articles 30 may be interchanged and rearranged to dynamically enhance the field of view.

For example, FIG. 5 attempts to illustrate a user's field of view encompassing an animal-themed arrangement of decorative articles 30. In this regard, it will be envisioned that each decorative surface 31 may comprise representative decorative animal markings for each animal-type decorative article 30 and the decorative article attachment surface 23 may comprise shades of green coloration to simulate a rainforest type background upon which the animal-type decorative articles 30 may be positioned. Though not specifically illustrated, each frame loop fastening means 24 may comprise shades of brown coloration such that when the user removes an animal-type decorative article 30 for rearrangement purposes, frame loop fastening means 24 will be exposed and preferably exhibit a circular pattern of brown coloration complementary to the green coloration of decorative article attachment surface 23.

As a further example, FIG. 4 attempts to illustrate a user's field of view encompassing a Christmas or winter theme. In this regard, it will be envisioned that each decorative surface 31 may comprise representative decorative Christmas or winter-type markings for seasonal decorative articles 30 and the decorative article attachment surface 23 may comprise white coloration to simulate a snow-covered background upon which the seasonal decorative articles 30 may be positioned. Though not specifically illustrated, each frame loop fastening means 24 may comprise shades of red or green coloration such that when the user removes a seasonal decorative article 30 for rearrangement purposes, frame loop fastening means 24 will be exposed and preferably exhibit a circular pattern of red or green coloration complementary to the white coloration of decorative article attachment surface 23.

As earlier stated, users of computers are enabled to receive or perceive computer-generated information via various output devices. One of the most common devices for enabling users to receive or perceive computer-generated information is through the use of visual output device such as a view screen or computer monitor display screens. Viewing screens or computer monitor display screens typically comprise a substantially vertical display screen or projection screen and a view screen peripheral border, both of which are typically rectangular in shape. The view screen peripheral border essentially frames the display screen and may comprise interactive components such as a power button, viewing adjustment means and the like. As has been described, the present invention provides a view screen peripheral border ornamentation system comprising, in combination, a computer monitor, a conjugate frame member and a plurality of decorative articles as described above. The conjugate frame member is sized, shaped and constructed so as to interface decorative articles with the peripheral border of the anterior face of a typical computer monitor or similar other display unit. The decorative articles may comprise thematic decorative articles and may be readily interchanged and rearranged on the anterior periphery according to the whim and fancy of the user. It is to be understood that the present invention provides a computer monitor or view screen ornamentation system that enables the user to outfit the view screen or monitor with lightweight, subtle or inconspicuous, user-viewable adornments. In this regard, it is noted that the management of businesses and the like do not permit the placement of unsightly “decorative” accessories on or around the workstations primarily because the “decorative” accessories often become obnoxious to the customer or client. Lightweight, inconspicuous adornments such as decorative articles 30 are typically less distracting to others and enable workplace users to foster a higher standard of professionalism in the workplace. By enabling users to readily adorn the anterior periphery of a monitor or view screen, ornamentation may still be achieved, yet the adornments do not extend into spaces adjacent to the monitor housing where passersby may become distracted. The present invention thus enables to user to adorn a monitor screen in such a manner so as to enable maintenance of a subtle or non-distracting monitor or view screen enhancement system. The ornamentation system or decorative frame assembly of the present invention thus functions to enable display screen users to dynamically enhance the visual experience of display screen use in an inconspicuous manner.

Alternative Embodiment

The alternative embodiment of the present invention is virtually identical to the preferred embodiment of the present invention save for conjugate frame member 20 and the various fastening means associated therewith. In this regard, it is contemplated that conjugate frame member 20 may be alternatively constructed from a flexible material and thus be capable of being rolled for ease of storage and shipment as is generally illustrated in FIG. 6. In this regard, it is contemplated that the preferred material of the alternative conjugate frame member 20 be sufficiently flexible to be furled into a substantially cylindrical configuration for shipment or storage. Flexible type plastic material, for example, may readily be sized and shaped to overlay view screen peripheral border 12 and further may readily receive adhesively attached fastening means. Modest results have been obtained by constructing conjugate frame member 20 from flexible plastic materials.

Excellent results have been obtained, however, by constructing alternative conjugate frame member 20 from fibrous, felt-like material. In this regard, VELVET LOOP brand display fabric fabricated by SUPERJOR FOMEBORDS CORPORATION of Chicago, Ill., as well as SHOWLOOP, FANFARE, and DURAFELT brand display fabrics fabricated by BLANKS of Baltimore, Md. provide examples of excellent materials from which to construct alternative conjugate frame member 20. Preferably, the alternative material comprises outwardly extending loop-like fibers, which fibers further define the frame loop fastening means 24 of the alternative conjugate frame member 20. In other words, decorative article attachment surface 23 comprises frame loop fastening means 24, which frame loop fastening means 24 are essentially the outwardly extending loop-like fibers of the fibrous, felt-like fabric. Thus, in the alternative embodiment, separate elements of VELCRO brand loop fastening structure need not be affixed to decorative article attachment surface 23 since the structure of the material provides loop fastening structure for removably receiving article hook fastening means 34 of each decorative article 30.

Similarly, since the outwardly extending loop-like fibers of the fibrous, felt-like fabric are also situated on peripheral border attachment surface 21, matable border hook fastening means are fixedly attached to view screen peripheral border 12 for removably receiving the outwardly extending loop-like fibers. The border hook fastening means and the loop-like fibers on peripheral border attachment surface 21 are thus matable and function to removably position conjugate frame member 20 in anterior adjacency to view screen peripheral border 12. It should be noted that the matable hook fastening structure and matable loop fastening structure are reversed between peripheral border attachment surface 21 and view screen peripheral border 12 in the alternative embodiment. While the hook type fastening structure will encounter and receive unsightly air borne fibers and the like as earlier discussed, these drawbacks are outweighed by the fact that separate elements of fastening means need not be affixed to peripheral border attachment surface 21 since the structure of the material provides loop fastening structure for removably attaching alternative conjugate frame member 20 to view screen peripheral border. FIG. 5 attempts to generally illustrate the outwardly extending loop like fibers of decorative article attachment surface 23 in contradistinction to the relatively smooth decorative article attachment surface 23 as generally illustrated in FIG. 4. A comparison of the two figures will show the differently configured decorative article attachment surfaces 23.

Kit Considerations

The present invention further concerns a decorative framing kit 40 as generally illustrated in FIG. 6. Decorative framing kit 40 is designed to enable users to ornamentally outfit a computer monitor peripheral border or view screen peripheral border 12 as earlier described. Decorative framing kit 40 may preferably comprise conjugate frame member 20, which may or may not be prefabricated so as to be sized and shaped to overlay view screen peripheral border as earlier described. The kit based conjugate frame member 20 must, however, be formable so as to enable the consumer to form the conjugate frame member 20 according to the size and shape of a given view screen peripheral border 12. It is contemplated that view screen peripheral borders vary greatly in size and shape and thus it is here specified that the kit-based conjugate frame member be formable to account for the varied view screen peripheral borders. Decorative framing kit 40 further comprises a plurality of decorative articles 30 as described above and as further illustrated in FIG. 6. Further, decorative framing kit 40 further comprises frame fastening means for removably attaching conjugate frame member 20 to the computer monitor peripheral border or view screen peripheral border 12; and article fastening means for removably attaching each decorative article 30 to decorative article attachment surface 23. The frame fastening means and the article fastening means preferably comprise VELCRO brand hook and loop fastening structure, which may be included in decorative framing kit 40, for example, in rolled form as referenced at 41 in FIG. 6. Alternatively, the preferred VELCRO brand hook and loop fastening structure may be included in decorative framing kit 40 in mated circular tab form, thus accounting for the preferred circular configured hook and loop fastening structure as earlier described.

As earlier stated, users of computers are enabled to receive or perceive computer-generated information via various output devices. One of the most common devices for enabling users to perceive computer-generated information is through the use of visual output device such as a view screen or computer monitor display screens. Viewing screens or computer monitor display screens typically comprise a substantially vertical display screen and a view screen peripheral border, both of which are typically rectangular in shape. The view screen peripheral border essentially frames the display screen and may comprise interactive components such as a power button, viewing adjustment means and the like. The present invention provides a view screen peripheral border ornamentation system comprising, in combination, a computer monitor, a conjugate frame member and a plurality of decorative articles as described above. The conjugate frame member is sized, shaped and constructed so as to interface decorative articles with the peripheral border of the anterior face of a typical computer monitor or similar other display unit. Further, the conjugate frame member may be constructed from materials having outwardly extending loop-like matable fibers, which fibers mate with hook type fastening means fixedly attached to the view screen peripheral border and each decorative article. The decorative articles may comprise thematic decorative articles and may be readily interchanged and rearranged on the anterior periphery according to the whim and fancy of the user. The ornamentation system or decorative frame assembly of the present invention thus functions to enable display screen users to dynamically enhance the visual experience of display screen use in an inconspicuous manner.

It will thus be seen that the present invention provides a visual enhancement system for use in combination with a computer monitor or other similar type view screen. In this regard, it will be seen that the present invention provides a computer monitor or view screen ornamentation system that is low is cost and less cumbersome to practice than other prior art computer monitor decorative systems. Further, it will be seen that the present invention provides a computer monitor or view screen ornamentation system that enables the user to outfit the view screen or monitor with lightweight, subtle or inconspicuous, user-viewable adornments. It will be further seen that the present invention provides a computer monitor or view screen ornamentation system that is less distracting to others and enables workplace users to foster a higher standard of professionalism in the workplace. It will also be seen that the present invention provides a computer monitor or view screen ornamentation system that enables the user to readily adorn the anterior periphery of a monitor or view screen such that the user may more easily maintain a subtle or non-distracting monitor or view screen enhancement system. In other words, the present invention provides a computer monitor or view screen decorative device that enables users to readily manipulate user-viewable ornamental pieces located on the anterior periphery of a monitor view screen.

It will be seen that the present invention further provides a computer monitor or view screen decorative assemblage that enables the user to readily interchange and/or rearrange decorative adornments such that the anterior periphery of a monitor or view screen may be dynamically or continuously enhanced according to the user's whim and fancy. Further, it will be seen that the present invention provides a computer monitor or view screen decorative assemblage that enables the user to readily interchange and/or rearrange thematic adornments such that the anterior periphery of a monitor or view screen may be dynamically enhanced according to themes. The noted decorative monitor themes may be practiced in a relatively inconspicuous fashion.

Still further, it will be seen that the present invention provides a computer monitor or view screen decorative assemblage that provides decorative fastening means usable to attach decorative articles to a given computer monitor or view screen. As stated, the prior art fastening means often comprise distracting attachment structures, which tend to decrease the visual appeal as well as the value of a computer monitor. It will thus be seen that present invention provides fastening means, which are highly decorative or visually appealing.

While the above description contains much specificity, this specificity should not be construed as limitations on the scope of the invention, but rather as an exemplification of the invention. For example, it is contemplated that view screens or display screens may comprise configuration other than rectangular type screens. So long as the conjugate frame member overlays the view screen peripheral border of a computer monitor or like display device as a means for interfacing decorative articles with a display screen, it is believed that the present invention is practiced. Further, it is contemplated that the present invention may be practiced by eliminating the conjugate frame member and attaching the decorative articles directly to the anterior periphery of a computer monitor display screen or other similar display screen. In this regard, should the anterior periphery comprise fixedly attached border fastening means for removably receiving decorative articles, the decorative articles with article fastening means cooperatively associated therewith may easily be removably attached to the view screen peripheral border in user-selected arrangements.

Accordingly, although the invention has been described by reference to a preferred embodiment, an alternative embodiment and a kit based on the preferred and alternative embodiments, it is not intended that the novel assemblies and kit be limited thereby, but that modifications thereof are intended to be included as falling within the broad scope and spirit of the foregoing disclosure, the following claims and the appended drawings.

I claim:

1. A computer monitor ornamentation system for enabling a user to continuously enhance the user's field of monitor view, the computer monitor ornamentation system comprising, in combination:
a computer monitor, the computer monitor comprising a substantially vertical view screen and a substantially rectangular view screen peripheral border, the view screen peripheral border comprising a substantially horizontal superior base frame portion, a substantially horizontal inferior base frame portion, a substantially vertical left base frame portion, a substantially vertical right base frame portion, and fixedly attached border loop fastening means;
a substantially rectangular conjugate frame member, the conjugate frame member comprising a substantially horizontal superior conjugate frame portion, a substantially horizontal inferior conjugate frame portion, a substantially vertical left conjugate frame portion, a substantially vertical right conjugate frame portion, a peripheral border attachment surface, frame hook fastening means fixedly attached to the peripheral border surface, a decorative article attachment surface, and frame loop fastening means fixedly attached to the decorative article attachment surface, the frame hook fastening means for removably attaching the conjugate frame member to the border loop fastening means, the conjugate frame member being sized and shaped for removable attachment to the view screen peripheral border such that the superior conjugate frame portion overlays the superior base frame portion, the inferior conjugate frame portion overlays the inferior base frame portion, the left conjugate frame portion overlays the left base frame portion, and the right conjugate frame portion overlays the right base frame portion; and
a plurality of decorative articles, each decorative article comprising a decorative surface, a frame-engaging surface, a button fixedly attached to the frame-engaging surface, and article hook fastening means fixedly attached to the button, the article hook fastening means for removably attaching the decorative articles to the frame loop fastening means in user-selected arrangements, thus enabling a user to continuously enhance the user's field of monitor view by removably attaching the decorative articles to the conjugate frame member in user-selected arrangements.

2. The computer monitor ornamentation system of claim 1 wherein the buttons, article hook fastening means, and frame loop fastening means are each defined by comprising a substantially circular configuration.

3. The computer monitor ornamentation system of claim 1 wherein the conjugate frame member is defined by comprising a flexible material.

4. The computer monitor ornamentation system of claim 3 wherein the flexible material is defined by comprising fibrous felt-like fabric, the fibrous felt-like fabric comprising outwardly extending loop-like fibers, the loop-like fibers defining the frame loop fastening means.

5. The computer monitor ornamentation system of claim 4 wherein the decorative article attachment surface, frame loop fastening means, and the decorative surface are each defined by comprising decorative coloration.

6. The computer monitor ornamentation system of claim 5 wherein the decorative articles are defined by comprising thematic decorative articles.

7. A view screen ornamentation system for enabling a user to continuously enhance the user's field of screen view, the view screen ornamentation system comprising, in combination:
a substantially vertical view screen, the view screen comprising a substantially rectangular view screen peripheral border, the view screen peripheral border comprising a substantially horizontal superior base frame portion, a substantially horizontal inferior base frame portion, a substantially vertical left base frame portion, a substantially vertical right base frame portion, and fixedly attached border fastening means; and
at least one decorative article, the decorative article comprising a decorative surface, a frame-engaging surface, and article fastening means cooperatively associated with the frame-engaging surface for enabling a user to continuously enhance the user's field of screen view by removably attaching the decorative article to the view screen peripheral border in user-selected arrangements.

8. The view screen ornamentation system of claim 7 wherein the system is defined by comprising a substantially rectangular conjugate frame member, the conjugate frame member comprising a substantially horizontal superior conjugate frame portion, a substantially horizontal inferior conjugate frame portion, a substantially vertical left conjugate frame portion, a substantially vertical right conjugate frame portion, a peripheral border attachment surface, border-frame fastening means fixedly attached to the peripheral border surface, a decorative article attachment surface, and frame-article fastening means fixedly attached to the decorative article attachment surface, the border-frame fastening means for removably attaching the conjugate frame member to the border fastening means, the conjugate frame member being sized and shaped for removable attachment to the view screen peripheral border such that the superior conjugate frame portion overlays the superior base frame portion, the inferior conjugate frame portion overlays the inferior base frame portion, the left conjugate frame portion overlays the left base frame portion, and the right conjugate frame portion overlays the right base frame portion, the article fastening means for removably attaching the decorative article to the frame-article fastening means in user-selected arrangements, thus enabling a user to continuously enhance the user's field of screen view by removably attaching the decorative article to the decorative article attachment surface in user-selected arrangements.

9. The view screen ornamentation system of claim 7 wherein the conjugate frame member is defined by comprising a flexible material.

10. The view screen ornamentation system-of claim 9 wherein the flexible material is defined by comprising fibrous felt-like fabric, the fibrous felt-like fabric comprising outwardly extending loop-like fibers, the loop-like fibers defining the border-frame fastening means and the frame-article fastening means.

11. The view screen ornamentation system of claim 10 wherein the decorative article attachment surface, frame-article fastening means, and the decorative surface are each defined by comprising decorative coloration.

12. The view screen ornamentation system of claim 11 wherein the decorative articles are defined by comprising thematic decorative articles.

13. A decorative frame assembly for use in combination with a computer monitor to enable a user to continuously enhance the user's field of monitor view, the decorative frame assembly comprising:
a conjugate frame member, the conjugate frame member comprising a peripheral border attachment surface, border-frame fastening means fixedly attached to the peripheral border surface, and a decorative article attachment surface, the border-frame fastening means for removably attaching the conjugate frame member to a computer monitor peripheral border, the conjugate frame member being sized and shaped to overlay the computer monitor peripheral border, thus enabling a user to frame the user's field of monitor view; and
a plurality of decorative articles, each decorative article comprising a decorative surface, a frame-engaging surface, and article fastening means fixedly attached to the frame-engaging surface, the article fastening means for removably attaching the decorative articles to the decorative article attachment surface in user-selected arrangements, thus enabling a user to continuously enhance the user's field of monitor view by removably attaching the decorative articles to the conjugate frame member in user-selected arrangements.

14. The decorative frame assembly of claim 13 wherein the decorative article attachment surface is defined by comprising frame loop fastening means.

15. The decorative frame assembly of claim 14 wherein the article fastening means are defined by comprising a button fixedly attached to each frame-engaging surface, and article hook fastening means fixedly attached to each button for removably attaching each button to the frame loop fastening means.

16. The decorative frame assembly of claim 13 wherein the conjugate frame member is defined by comprising a flexible material.

17. The decorative frame assembly of claim 16 wherein the flexible material is defined by comprising fibrous felt-like fabric, the fibrous felt-like fabric comprising outwardly extending loop-like fibers, the loop-like fibers defining the frame loop fastening means.

18. The decorative frame assembly of claim 17 wherein the decorative article attachment surface, frame loop fastening means, and the decorative surface are each defined by comprising decorative coloration.

19. The decorative frame assembly of claim 18 wherein the decorative articles are defined by comprising thematic decorative articles.

20. A decorative frame assembly for use in combination with a view screen to enable a user to continuously enhance the user's field of screen view, the decorative frame assembly comprising:
a conjugate frame member, the conjugate frame member comprising a peripheral border attachment surface, border-frame fastening means cooperatively associated with the peripheral border surface, and a decorative article attachment surface, the border-frame fastening means for removably attaching the conjugate frame member to a view screen peripheral border, the conjugate frame member being sized and shaped to overlay the view screen peripheral border, thus enabling a user to frame the user's field of screen view; and
at least one decorative article, the decorative article comprising a decorative surface, a frame-engaging surface, and article fastening means cooperatively associated with the frame-engaging surface, the article fastening means for removably attaching the decorative article to the decorative article attachment surface in user-selected arrangements, thus enabling a user to continuously enhance the user's field of screen view by removably attaching the decorative article to the conjugate frame member in user-selected arrangements.

21. The decorative frame assembly of claim 20 wherein the decorative article attachment surface is defined by comprising frame loop fastening means.

22. The decorative frame assembly of claim 21 wherein the article fastening means are defined by comprising a button fixedly attached to the decorative article, and article hook fastening means cooperatively associate with the button for removably attaching the button to the frame loop fastening means.

23. The decorative frame assembly of claim 20 wherein the conjugate frame member is defined by comprising a flexible material.

24. The decorative frame assembly of claim 23 wherein the flexible material is defined by comprising fibrous felt-like fabric, the fibrous felt-like fabric comprising outwardly extending loop-like fibers, the loop-like fibers defining the frame loop fastening means.

25. The decorative frame assembly of claim 22 wherein the decorative article attachment surface, frame loop fastening means, and the decorative surface are each defined by comprising decorative coloration.

26. The decorative frame assembly of claim 20 wherein the decorative articles are defined by comprising thematic decorative articles.

27. A decorative framing kit for ornamentally outfitting a computer monitor peripheral border, the decorative framing kit comprising:
a conjugate frame member, the conjugate frame member comprising a peripheral border attachment surface and a decorative article attachment surface, the conjugate frame member being formable to overlay a computer monitor peripheral border;
a plurality of decorative articles, each decorative article comprising a decorative surface and a frame-engaging surface;
frame fastening means for removably attaching the conjugate frame member to the computer monitor peripheral border; and
article fastening means for removably attaching each decorative article to the decorative article attachment surface.

28. The decorative framing kit of claim 27 wherein the decorative article attachment surface is defined by comprising frame loop fastening means.

29. The decorative framing kit of claim 28 wherein the article fastening means are defined by comprising a button for fixed attachment to each frame-engaging surface, and article hook fastening means cooperatively associated with each button for removably attaching each button to the frame loop fastening means.

30. The decorative framing kit of claim 29 wherein the buttons, article hook fastening means, and frame loop fastening means are each defined by comprising a substantially circular configuration.

31. The decorative framing kit of claim 27 wherein the conjugate frame member is defined by comprising a flexible material.

32. The decorative framing kit of claim 31 wherein the flexible material is defined by comprising fibrous felt-like fabric, the fibrous felt-like fabric comprising outwardly extending loop-like fibers, the loop-like fibers defining the frame loop fastening means.

33. The decorative framing kit of claim 32 wherein the decorative article attachment surface, frame loop fastening means, and the decorative surface are each defined by comprising decorative coloration.

34. The decorative framing kit of claim 33 wherein the decorative articles are defined by comprising thematic decorative articles.

35. A decorative framing kit for ornamentally outfitting a view screen peripheral border, the decorative framing kit comprising:
at least one decorative article, the decorative article comprising a decorative surface and a frame-engaging surface; and
article fastening means for removably attaching the decorative article to a peripheral border.

36. The decorative framing kit of claim 35 wherein the decorative framing kit comprises:
a conjugate frame member, the conjugate frame member comprising a peripheral border attachment surface and a decorative article attachment surface, the conjugate frame member being formable to overlay a view screen peripheral border; and
frame fastening means for removably attaching the conjugate frame member to the view screen peripheral border.

37. The decorative framing kit of claim 36 wherein the kit comprises frame loop fastening means.

38. The decorative framing kit of claim 36 wherein the conjugate frame member is defined by comprising a flexible material.

39. The decorative framing kit of claim 38 wherein the flexible material is defined by comprising fibrous felt-like fabric, the fibrous felt-like fabric comprising outwardly extending loop-like fibers, the loop-like fibers defining the frame loop fastening means.

40. The decorative framing kit of claim 39 wherein the decorative article attachment surface, frame loop fastening means, and the decorative surface are each defined by comprising decorative coloration.

41. The decorative framing kit of claim 40 wherein the article fastening means are defined by comprising a button for attachment to each frame-engaging surface, and article hook fastening means cooperatively associated with each button for removably attaching each button to the frame loop fastening means.

42. The decorative framing kit of claim 41 wherein the buttons, article hook fastening means, and frame loop fastening means are each defined by comprising a substantially circular configuration.
